(19) United States
(12) Patent Application Publication
(10) Pub. No.: US 2001/0056487 A1
(43) Pub. Date: Dec. 27, 2001

(54) Method and system for authenticating identity on internet

(76) Inventor: Chin Woo Yoo, Seoul (KR)

Correspondence Address: J.C. Patents, 1340 Reynolds Ave., #114, Irvine, CA, 92614, US

(21) Appl. No.: 09/747,013

(22) Filed: Dec. 22, 2000

(30) Foreign Application Priority Data
Dec. 24, 1999 (KR) 1999-61740
Nov. 18, 2000 (KR) 2000-68726

(51) Int. Cl. G06F 15/16

(52) U.S. Cl. 709/225; 709/219; 709/203

(57) ABSTRACT

A system and method for authenticating an identity on Internet is provided. The authentication system and method authenticates the identity of a user on the Internet whenever he/she needs to be authenticated through only one authentication procedure. The authentication system and method also checks the multiple registration of an applicant who wishes to register in a membership system web site or participate in an event permitting just one chance per man. The authentication system and method also checks the identity of a user logged on the membership system web site in a state where the user's anonymity is secured. Based on the fact that a subscriber has a personal resident registration number and/or a corporate/institute registration number, personal data about the subscriber's identity and credit is registered in a system server of the authentication system, and the authentication system is automatically linked to whenever the subscriber registers his/her identity to use, for example, electronic commerce on the Internet so that the subscriber's identity can be authenticated by the authentication system without proceeding with authentication whenever necessary, thereby allowing the subscriber to have a transaction on the Internet with the anonymity secured. In addition, subscriber information for each membership system web site is registered in the system server of the authentication system so that the multiple registration of a subscriber in a certain membership system web site can be checked. By authenticating the identity of a subscriber based on the guarantee of a guarantor (or a certification agency), the authenticated identity corresponds to the real subscriber one to one so that convenience in registering in web sites requiring identity authentication and the reliability on identities on the Internet can be improved, and the waste and misuse of resources due to multiple registration can be prevented.

### BACKGROUND OF THE INVENTION

1. Field of the Invention

The present invention relates to a method and system for authenticating an identity on the Internet, and more particularly, to an authentication method and system for authenticating the identity of a subscriber whenever authentication is necessary with only one authentication procedure on the Internet. Here, the identity indicates an Internet identity which is a real identity of a corresponding person existing in the real society one-to-one but guarantees anonymity without informing the outside of the system of who the person is.

2. Description of the Related Art

In the case of systems of authenticating passwords used for bankbooks and credit cards outside The Internet, a user should remember all passwords he/she uses for different bankbooks and credit cards. When the user forgets a password, he/she should go to a relevant issuing window and proceed with authentication to know the password.

As the Internet has rapidly been developed recently, and there have been frequent communications of information and resources through the Internet, authentication of the identity of an Internet user becomes more important. In addition, with development of electronic commerce through the Internet, it is more frequently required to authenticate and certify a personal identity and credit state. However, personal identity and credit state are not actually checked. In conventional authentication and registration system just verifies an identifier (ID) and a password input by a user and registers the ID if it has not been registered. Of course it is possible to authenticate a user using the user's name and resident registration number, but it is unreasonable to authenticate the user online with the above information easily revealed in daily life. In such conventional authentication systems, a user troubles to register personal information whenever it is required in different web sites. Moreover, the conventional systems cannot be used when the certification of a personal identity and the anonymity of information should be thoroughly secured, for example, in the case of an opinion poll or voting. In addition, it is difficult to prevent personal information registered by a subscriber from being revealed to the outside so that it is difficult to protect personal private life.

Conventional systems of registering a personal identity (including personal information and credit information) cannot prevent and check multiple registrations by one person and cannot cope with problems caused by multiple registration. When a person uses a plurality of IDs in a single site, it is difficult to seize the actual identity of the person, and there is an error in the total number of subscribers even if the identity of the person is understood. In such a system which cannot prevent a user from multiple-registering in a member registration site, problems of the waste of resources, difficulty in managing members and difficult in estimating the value of a site are caused by multiple registration and cannot be overcome. In the case of cyber public-opinion poll or voting, multiple participation cannot be excluded so that the statistics can be meaningless. Since conventional Internet identity registration systems cannot prevent multiple registration, they cannot be used for public-opinion poll and voting.

### SUMMARY OF THE INVENTION

To solve the above problems, it is a first object of the present invention to provide a method and system for authenticating an identity, for issuing a single Internet ID to one subscriber to allow the subscriber to register the ID and certifying the identity of the registered subscriber to the third party in the name of the subscriber on The Internet so that the Internet identity is authenticated in a state in which anonymity not allowing the outside of the authentication system, i.e., the third party, to identify the subscriber is secured.

It is a second object of the present invention to provide a method and system for securing the anonymity and personal information of an applicant for registration in a web site on the Internet when it is checked whether the applicant is about to multiple register.

Accordingly, to achieve the above objects of the invention, in one aspect, there is provided a method of authenticating the identity of an applicant for registration on The Internet. The method includes the steps of confirming the identity of the applicant for registration, assigning a unique Internet ID to the applicant whose identity is confirmed, and registering the personal information of the applicant in an authentication system together with a password.

When the applicant assigned the Internet ID needs to be authenticated on the Internet, the method also includes the steps of the applicant presenting the Internet ID to a membership system web site requiring the authentication of the applicant's identity, the membership system web site transmitting the Internet ID to the authentication system to request the authentication of the applicant's identity, and the authentication system requesting the applicant to input the password and informing the membership system web site that the applicant's identity is authenticated when the password input by the applicant is the same as that stored in the authentication system.

The method also includes the step of checking the multiple registration of the applicant assigned the Internet ID when the applicant intends to register in a web site as a member or participate in an event permitting just one chance per man. The multiple registration checking step includes the steps of receiving a request to check the multiple registration of the applicant and the site ID of the web site from the web site, receiving the applicant's Internet ID and password necessary for authentication on the Internet from the applicant and performing authentication, and determining whether the applicant has registered in the web site using the applicant's Internet ID and the site ID of the web site and transmitting the result of the determination to the web site.

When a user who has registered in the web site needs to be authenticated on the Internet, preferably, the method also includes the steps of the web site transmitting the user's member ID and the site ID to the authentication system and requesting authentication of the user's identity, the authentication system requesting the user to directly input his/her Internet ID and password or reading and processing the information of a cookie stored in the user's terminal to acquire the user's Internet ID and password, and the authentication system comparing the Internet ID and password of a user having the received site ID and the member ID with the acquired Internet ID and the password and transmitting the result to the web site.

In another aspect, there is provided a system for authenticating the identity of an applicant for registration on the Internet. The system includes a web site server for confirming the identity of the applicant for registration in the system, assigning a unique Internet ID to the applicant whose identity is confirmed, and registering the applicant's personal information together with a password under a secure state on the Internet; and a memory unit for storing the registered applicant's Internet ID, password and personal information.

In the system, when the applicant assigned the Internet ID needs to be authenticated on the Internet, the applicant presents the Internet ID to a membership system web site requiring the authentication of the applicant's identity, the membership system web site transmits the Internet ID to the authentication system to request the authentication of the applicant's identity, and the authentication system requests the applicant to input the password and informing the membership system web site that the applicant's identity is authenticated when the password input by the applicant is the same as that stored in the authentication system.

The system preferably stores the applicant's Internet ID in the memory unit in association with a site ID of the membership system web site. Accordingly, when checking the multiple registration of the applicant assigned the Internet ID when the applicant intends to register in a web site as a member or participate in an event permitting just one chance per man, the system receives the request to check the multiple registration of the applicant and a site ID from the web site, receives the applicant's Internet ID and password necessary for authentication on the Internet from the applicant and performs authentication, and determines whether the applicant has registered in the web site using the applicant's Internet ID and the site ID of the web site and transmits the determined result to the web site.

Preferably, when a user who has registered in the web site needs to be authenticated on the Internet, the web site transmits the user's member ID and the site ID to the authentication system and requests authentication of the user's identity, the authentication system requests the user to directly input his/her Internet ID and password or reads and processes the information of a cookie stored in the user's terminal to acquire the user's Internet ID and password, and the authentication system compares the Internet ID and password of a user having the received site ID and the member ID with acquired the Internet ID and the password and transmits the result to the web site.

### BRIEF DESCRIPTION OF THE DRAWINGS

The above objectives and advantages of the present invention will become more apparent by describing in detail preferred embodiments thereof with reference to the attached drawings in which:

FIG. 1 is a schematic diagram illustrating an authentication system for explaining a method of authenticating an identity on The Internet according to the present invention;

FIG. 2 is a flowchart illustrating a procedure of registering the identity of a new subscriber in an authentication system according to the present invention;

FIG. 3 is a flowchart illustrating a procedure through which a user who has registered the identity in an authentication system confirms his/her identity in a web site, according to the present invention;

FIG. 4 is a flow chart illustrating a procedure of certifying the address and name of a user, who has registered the identity in an authentication system, to a web site in response to the user's request and transmitting access/transaction details from the web site to the user, thereby preventing the misappropriation of an Internet ID, according to the present invention;

FIG. 5 is a flowchart illustrating a procedure of determining the multiple registration of an applicant when the applicant who has registered in an authentication system is about to assigned a member ID by a membership system web site after the applicant's identity is authenticated, according to the present invention;

FIGS. 6A through 6D illustrate examples of user interface for checking the multiple registration of an applicant for registration in a membership system web site, according to the present invention;

FIG. 7 is a flowchart illustrating a method of authenticating the identity of a user, who has already been assigned a member ID by a membership system web site after being authenticated, in a state in which the anonymity is secured;

FIGS. 8A through 8D illustrate the examples of user interface for authenticating the identity of a user in a state in which the anonymity is secured;

FIG. 9A is a schematic diagram illustrating a conventional one-click shopping method using a cookie;

FIG. 9B a schematic diagram illustrating a one-click shopping method using a cookie through an authentication system according to the present invention;

FIGS. 10A and 10B illustrate examples of a table format stored in a memory unit of an authentication system according to the present invention; and

FIGS. 11A and 11B illustrate examples of another table format according to the present invention.

### DETAILED DESCRIPTION OF THE PRESENT INVENTION

Hereinafter, a method of authenticating the identity of a subscriber on The Internet and the configuration and operation of an authentication system therefor according to embodiments of the present invention will be described in detail with reference to the attached drawings.

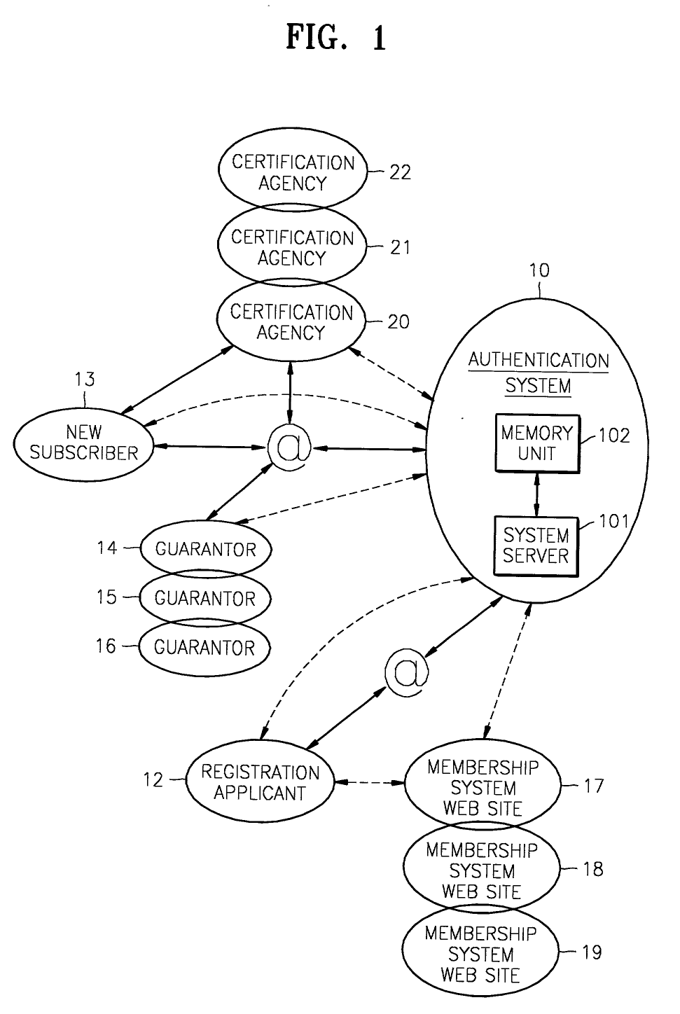

FIG. 1 is a schematic diagram illustrating an authentication system for explaining a method of authenticating an identity on the Internet according to the present invention. As shown in FIG. 1, an authentication system 10 on the Internet according to the present invention issues a unique anonymous Internet ID to a new subscriber 13 when the identity of the new subscriber 13 has been authenticated. When the new subscriber 13 has one of guarantors 14, 15, 16, . . . the registration of the new subscriber 13 in the authentication system is allowed by the security given by the guarantor 14, 15 or 16 (when the guarantor 14, 15, 16 or . . . directly deliver an authentication key to the new subscriber 13, an arrow headed line from the guarantor 14, 15, 16 or . . . toward the new subscriber 13 is necessary in FIG. 1). In this case, more than one guarantors may be required. When the new subscriber 13 does not have any guarantor, the new subscriber 13 is allowed to register in the authentication system after he/she has been authenticated by a predetermined certification agency 20, 21, 22 or . . . . When transacting business with a membership web site 17, 18, 19 or . . . , a registration applicant 12 makes the authentication system 10 identify the identity of the registration applicant 12 in the name of the registration applicant 12 for the membership web site 17, 18, 19 or . . . .

In addition, the authentication system 10 according to the present invention stores the Internet ID of an applicant for registering in the membership system web site 17, 18, 19 or . . . in association with the ID used by the applicant at the membership web site 17, 18, 19 or . . . so that the authentication system 10 can check whether the registration applicant 12 is about to multiple register in the membership web site 17, 18, 19 or . . . when he/she registers in the membership web site 17, 18, 19 or . . . or participates in an event permitting only one chance per hand.

In FIG. 1, the solid lines illustrate a communication system using e-mail over the Internet. In other words, the new subscriber 13, the guarantor 14, 15, 16 or . . . the certification agency 20, 21, 22 or . . . and the authentication system 10 communicate information with one another using e-mail. However, since e-mail is weak in security, it is not proper for transmitting information containing secured information such as an ID or a password. Accordingly, it is preferable for the communication between the subscriber 13 and the authentication system 10 that the secured information is transmitted under a state in which security is preserved, for example, under an access state through a secured socket layer (SSL). Most information is transmitted through a HyperText Transfer Protocol (HTTP), but it is convenient to use an e-mail when an authentication key is sent to a guarantor, or when the access/purchasing report of a membership system web site is sent to a member. In addition, a new subscriber may visit a certification agency by himself/herself or submit a notarized paper to the certification agency to be authenticated his/her identity. The dotted lines in FIG. 1 illustrate that the authentication system 10 directly accesses web sites or client computers on the Internet and communicates information with them. Here, e-mail can be used together for input and transmission of information. An Internet ID may be one-sidedly issued by the authentication system 10, or an ID input by a subscriber may be registered in the authentication system 10 after it is checked to avoid duplication.

For the authentication system 10 of the present invention, a normal personal computer, a workstation computer or a high speed mass computer can be appropriately used depending on the number of subscribers. The authentication system 10 includes a system server 101 as a basic computer element for processing data and a memory unit 102 for storing the processed data. Besides, the authentication system 10 includes input/output units such as a keyboard, a mouse, a monitor and a printer. For the memory unit 101, a hard disk (HD), a laser disk (LD), a compact disk (CD), a digital video disk (DVD) or a DVD-random access memory (RAM) which allows a large amount of data to be processed at high speed can be used, but it is preferable to use a HD.

The following description concerns a procedure of registering an identity in an authentication system according to the present invention, a procedure of authenticating the identity of a user registered in the authentication system at the membership system web site 17, 18, 19 or . . . , and a procedure of checking the duplicate registration of the identity of the user at the membership system web site 17, 18, 19 or . . . , based on the configuration of FIG. 1.

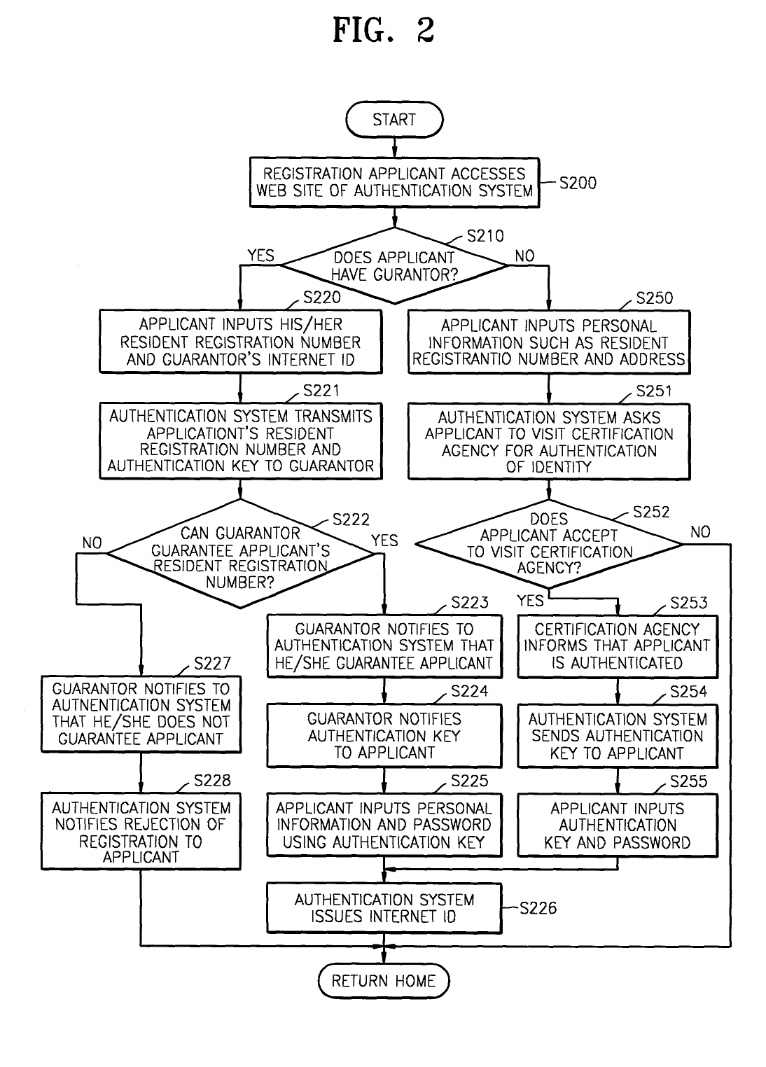

FIG. 2 is a flowchart illustrating a procedure of registering the identity of a new subscriber in an authentication system according to the present invention. In a method of authenticating the identity of a subscriber on the Internet, an Internet ID issuing procedure starts with step S200 in which an applicant, who wishes to register in the authentication system, accesses the web site of the authentication system. In step S210, the web site of the authentication system asks the registration applicant whether he/she has a guarantor. When there is a guarantor, the Internet ID issuing procedure is performed through steps S220 to S226. In step S220, the registration applicant inputs his/her resident registration number and the resident registration number or Internet ID of the guarantor at the web site of the authentication system. Any other ID number such as a passport number or a social security number cannot be used instead of resident registration number. In step S221, the authentication system transmits the resident registration number of the registration applicant and an authentication key to the guarantor. Here, the resident registration number of the registration applicant and the authentication key can be sent to the guarantor using an e-mail or to the wireless telephone or the like of the guarantor, or only registration applicant information can be notified to the guarantor to let the guarantor access the web site of the authentication system. In step S222, the guarantor determines whether he/she can guarantee the applicant's resident registration number. When determining that he/she can, the guarantor notifies to the authentication system that he/she will guarantee the applicant in step S223. Next, in step S224, the guarantor sends the authentication key transmitted from the authentication system to the registration applicant. In step 225, the registration applicant inputs personal information and a password to the authentication system using the authentication key. In step S226, the authentication system register the personal information and the password and issues a unique Internet ID to the registration applicant. It is preferable that communication for registration and verification of the personal information and the password is accomplished at a secured state. For the ID and password of a subscriber, alpha numeric information selected by the subscriber can be used, or a technique of sensing and transmitting a finger print, voice or handwriting sample which is a personal unique characteristic can be used. In addition, the Internet ID can be issued to the registration applicant using an e-mail, or it can be issued at the web site. The Internet ID and information registered in the authentication system can be printed and delivered to the applicant by mail, or the Internet ID can be notified to the applicant using communication means such as a wireless phone. A method of issuing the Internet ID can be appropriately designed depending on an environment to which the authentication system is applied. When the guarantor determines that he/she cannot guarantee the applicant in step S222, the guarantor notifies to the authentication system that he/she does not guarantee the applicant in step S227. Then, in step S228, the authentication system notifies the rejection of registration to the registration applicant and goes to the homepage of the web site.

In this embodiment, a registration applicant receives an authentication key necessary for registration from a guarantor and registers in an authentication system. Unlikely, the registration in an authentication system may be accomplished such that after a registration applicant provisionally registers in an authentication system and receives an authentication key, a guarantor receives the authentication key from the registration applicant, confirms the identity of the registration applicant and transfers the provisional registration into a formal registration.

Meanwhile, when there is no guarantor in step S210, the registration applicant inputs his/her personal information such as a resident registration number and an address to the authentication system in step S250. Since an authentication system according to the present invention should authenticate an identity one-to-one corresponding to a person existing in the real society, an applicant should be authenticated by the authentication system personally or through a certification agency if the applicant does not have a guarantor. It will be apparent to those skilled in the art that a method of comparing stored data of a personal unique characteristic such as a finger print, voice or handwriting sample with data currently input, a method of simply investigating a paper notarized by a notary public or a certification of authentication issued by the authorities, or a method of directly comparing such a certifying paper as described above with an actual identity and investigating the paper may be used. In FIG. 2, as a preferable embodiment, a procedure that a registration applicant is authenticated by a certification agency will be described.

Once the registration applicant inputs his/her personal information such as a resident registration number and an address in step S250, the authentication system asks the registration applicant to visit a nearby certification agency and proceed with authentication of the identity of the registration applicant himself/herself in step S251. In step S252, the registration applicant determines whether to visit the certification agency. When the identity of the registration applicant is proved, the certification agency informs the authentication system that the registration applicant is authenticated in step S253. Then, in step S254, the authentication system gives the registration applicant an authentication key through the certification agency. In step 255, the registration applicant completes the registration at the web site of the authentication system using the authentication key so that the personal information of the registration applicant is stored in the memory unit 102 of the authentication system. Next, in step S226, the authentication system issues an Internet ID. As described above, the communication among the certification agency, the authentication system and the registration applicant is accomplished using e-mail or directly at the web site of the authentication system on the Internet or using a personal terminal such as a wireless telephone. It will be apparent that an authentication key is not necessary in the case where an Internet ID is immediately issued through the terminal of the certification agency.

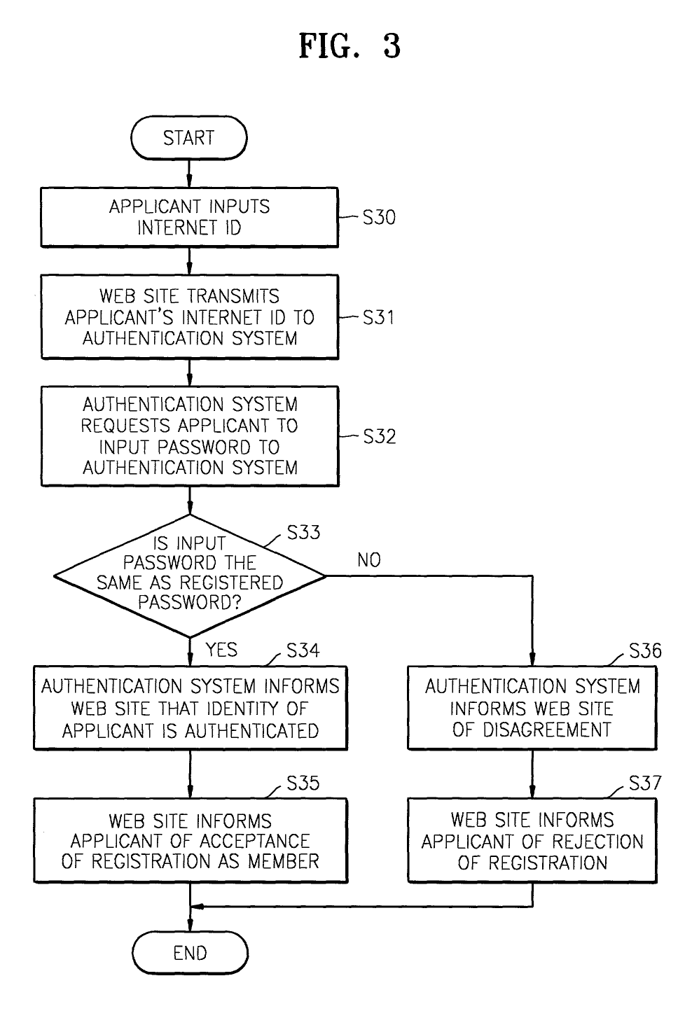

FIG. 3 is a flowchart illustrating a procedure through which a subscriber who has registered the identity in an authentication system of the present invention confirms his/her identity in a web site. As described above with reference to FIG. 2, when an applicant needs to be authenticated on the Internet after being registered in the authentication system and assigned an Internet ID, he/she can be authenticated by presenting the Internet ID to a membership system web site using the authentication system. This will be described with reference to FIG. 3.

As shown in FIG. 3, when an applicant for membership having an Internet ID needs to be authenticated at a web site on the Internet, he/she presents the Internet ID to the web site requesting authentication of his/her identity in step S30. Here, the applicant can directly input the Internet ID at the web site on the Internet or transmit the Internet ID to the membership system web site through a terminal such as a wireless telephone. Once receiving the Internet ID, the membership system web site transmits the Internet ID to the authentication system and asks authentication in step S31. Then in step S32, the authentication system requests the applicant to input a password (usually an alpha numeric password, but the various forms such as a finger print, voice and handwriting sample can be used as a password). In step S33, it is determined whether an input password is the same as a registered password. When they are the same, the authentication system informs the web site that the identity of the applicant is authenticated in step 34. Next in step S35, the web site informs the applicant that registration as a member or transaction has been validly performed. When it is determined the passwords are not the same in step S33, the authentication system informs the web site of disagreement in step S36. In step S37, the web site informs the applicant of rejection of registration or transaction and completes the operation.

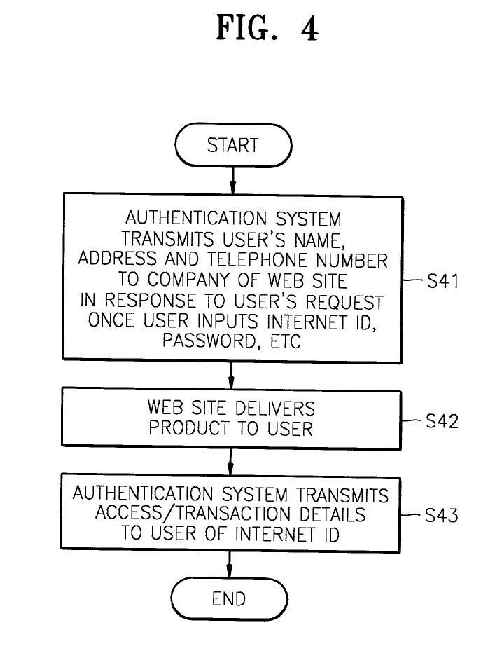

FIG. 4 is a flow chart illustrating a procedure of certifying the address and name of a user, who has registered the identity in an authentication system of the present invention, to a web site in response to the user's request and transmitting access/transaction details from the web site to the user, thereby preventing the misappropriation of an Internet ID. As shown in FIG. 4, in step S41, once a user inputs his/her Internet ID, password, etc. to the authentication system, the authentication system informs the web site of the user's name, address and telephone number necessary for delivering a product in response to the user's request. Here, the name, address and the telephone number necessary for the delivery of a product are transmitted to the company of the web site through e-mail or at the web site in real time. Then, the web site may report transaction details to the authentication system and request the authentication system to settle an account. Next, in step S42, the authentication system transmits access/transaction details to the user of the Internet ID periodically or whenever a transaction is made to allow the user to confirm them so that misappropriation of the Internet ID can be prevented.

FIG. 5 is a flowchart illustrating a procedure of determining the multiple registration of an applicant when the applicant who has registered in an authentication system is about to assigned a member ID by a membership system web site after the applicant's identity is authenticated, according to the present invention. Referring to FIG. 5, in step S50, a registration applicant accesses a membership system web site through the Internet. In step S51, once the registration applicant inputs a member ID he/she wishes to use at the web site through user interface, the membership system web site transmits the member ID and a site ID to an authentication system. The site ID is predetermined by the authentication system to identify the membership system web site. In step S52, the authentication system 10 requests the registration applicant to input his/her Internet ID and password that have been registered in the memory unit of the authentication system and receives them. In step S53, the authentication system determines authentication of the registration applicant's identity depending on whether the Internet ID and password input by the registration applicant are the same as those stored in the memory unit. When they are not the same, the authentication system informs the membership system web site that the registration applicant is not authenticated in step S54. When they are the same, the authentication system searches the memory unit 102 to check whether the Internet ID has already been registered in the membership system web site in step S55. In step S56, it is determined whether the registration applicant has registered in the membership system web site from the searched result. When the registration applicant has already registered in the membership system web site, the authentication system transmits the fact and the already registered member ID of the registration applicant to the membership system web site in step S57. When the registration applicant has not registered in the membership system web site, the authentication system stores the Internet ID and the member ID to be used in the membership system web site in association with the site ID in step S58 and informs the membership system web site that the registration applicant has not yet registered in the membership system web site in site S59.

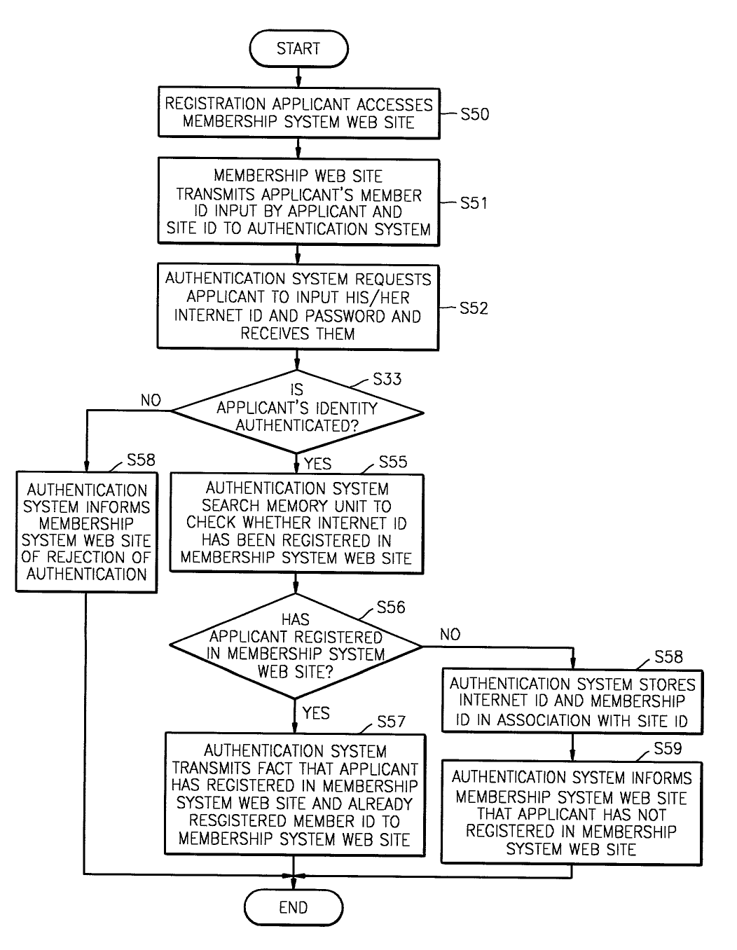

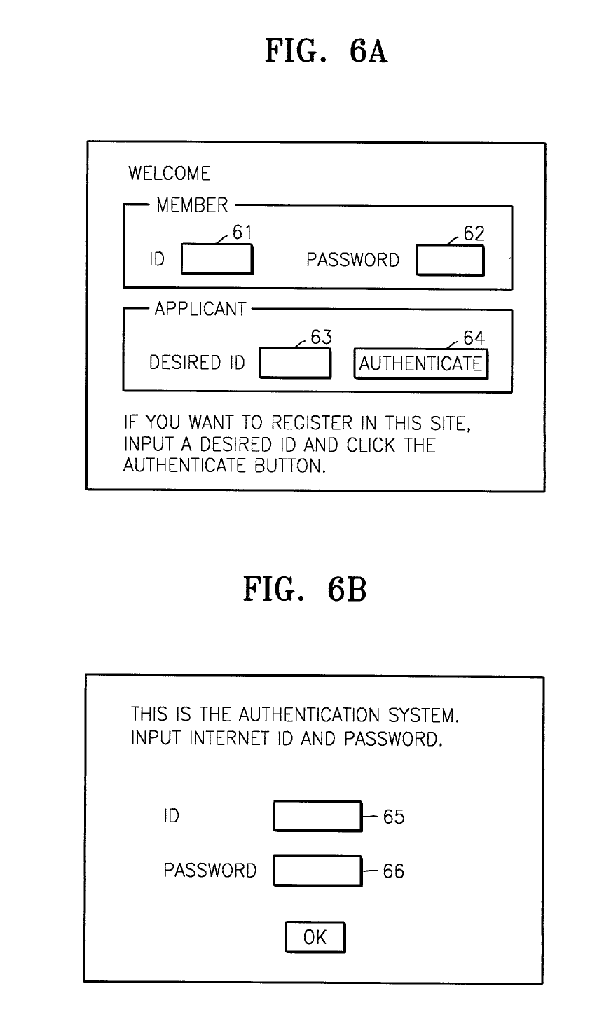

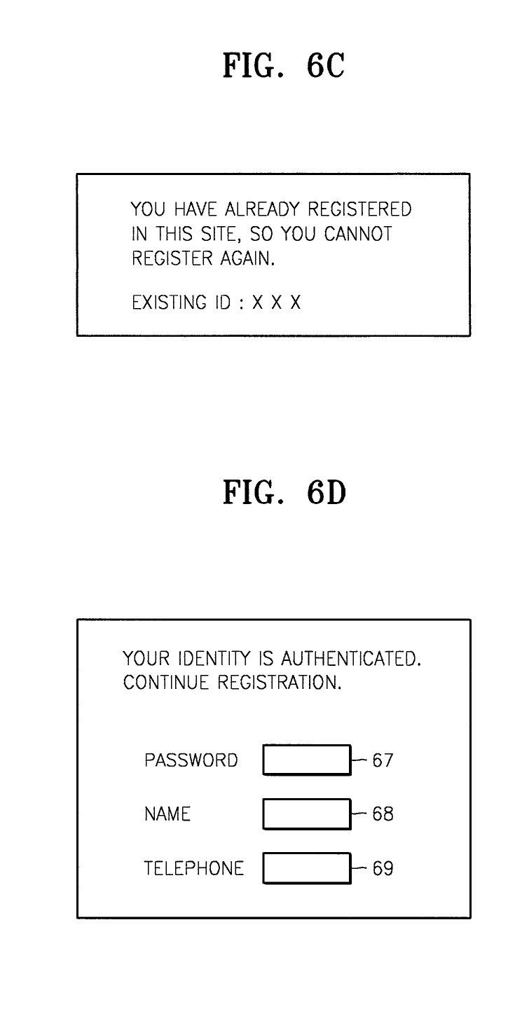

FIGS. 6A through 6D illustrate examples of user interface screens displayed on the terminal of the registration applicant 12 of FIG. 1 for registration in the membership system web site 17, 18, 19 or . . . . FIG. 6A illustrates an example of a screen on which the membership system web site 17, 18, 19 or . . . requests the applicant to input a desired member ID and request authentication in the step S51 of FIG. 5. Referring to FIG. 6A, an ID input section 61 and a password input section 62 for allowing an existing member to log in are provided at the upper portion. For the applicant 12 for new registration, a desired ID input section 63 and an authenticate button 64 for requesting authentication are provided. If a user is a registered member, he/she can log in by typing his her ID and password in the ID input section 61 and the password input section 62, respectively. If a user wants to register, he/she needs to input an ID he/she desires to use and click the authenticate button 64. Once authentication is requested, a control authority shifts to the authentication system 10 through, for example, the following HyperText Markup Language (HTML) and script language.

<FORM method=post action=http://internetID.co.kr/confirm.asp.>

<input type=text name=userID>

<input type=hidden name=siteID>

</FORM>

FIG. 6B illustrates a screen on which the authentication system 10 requests the registration applicant 12 to input an Internet ID and a password in the step S54 using the HTML and script language. In other words, once the registration applicant 12 clicks the authenticate button 64 of FIG. 6A, the ID desired by the registration applicant 12 is transmitted to a program “confirm.asp” provided by the authentication system “internetID.co.kr” as a parameter together with the site ID of the membership system web site 17, 18, 19 or . . . . The program “confirm.asp” transmits an interface screen as shown in FIG. 6B to the registration applicant's terminal. The registration applicant 12 inputs his/her Internet ID and password in the ID input section 65 and the password input section 66, respectively, and transmits them to the system server 101. Here, the ID input section 65 and the password input section 66 are provided from the system server 101 so that the registration applicant's Internet ID and password are not revealed to the membership system web site 17, 18, 19 or . . . , thereby enhancing the security.

FIG. 6C illustrates a screen transmitted to the registration applicant's terminal when the registration applicant 12 has already registered in the membership system web site 17, 18, 19 or . . . in the step S57. It is preferable to inform the registration applicant 12 of the member ID that has already been used by the registration applicant 12 at the membership system web site 17, 18, 19 or . . . .

FIG. 6D illustrates a screen on which the membership system web site 17, 18, 19 or . . . requests the registration applicant 12 to continue registration after it is confirmed that the registration applicant 12 has not yet registered in step S59. A personal information section including a name section and a telephone number section can be filled by the registration applicant 12, but it is preferable that the personal information stored in the memory unit 102 of the authentication system 10 is transmitted to the membership system web site 17, 18, 19 or . . . and automatically fills the personal information section upon the applicant's approval. Here, it is required that the control authority that has been shifted to the authentication system “internetID.co.kr” is turned back to the membership system web site 17, 18, 19 or . . . , and the state before the authentication was requested is exactly maintained. To meet this requirement, in one approach, authentication is performed on a separate window, and the authenticated result is stored as a variable on the current window. It will be obvious to those skilled in the art that other various methods using a session and a cookie may be used. Accordingly, the registration applicant 12 for registration in the membership system web site 17, 18, 19 or . . . can acquire a unique ID which can be used at membership system web site 17, 18, 19 or . . . without revealing his/her personal information including the Internet ID and password to others except the authentication system 10.

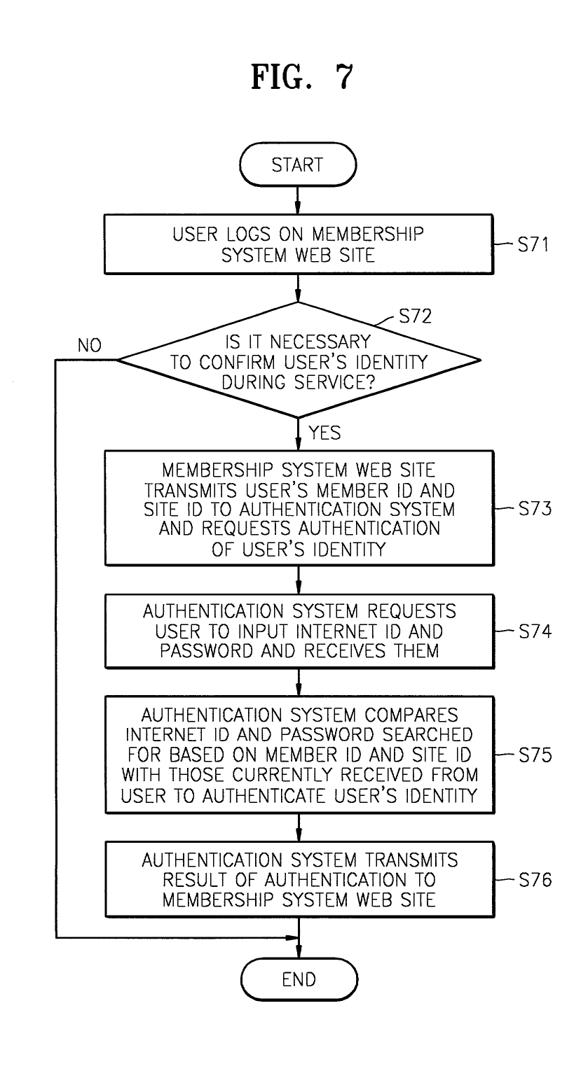

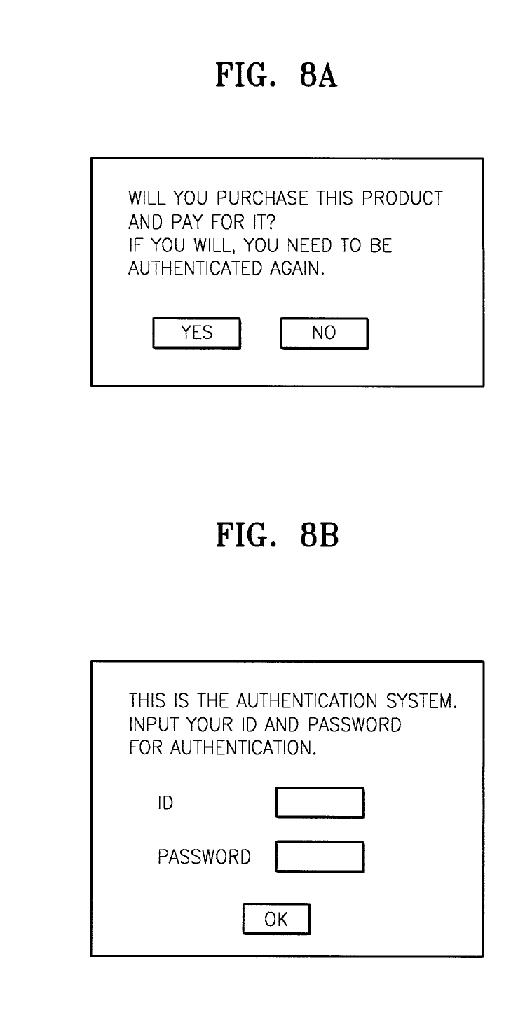

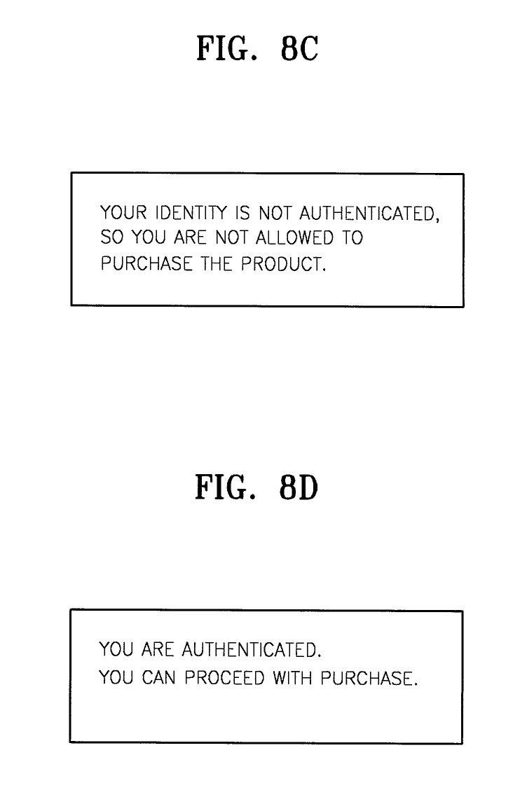

A user assigned a unique ID that can be used in a membership system web site can purchase a product on the Internet in a state where the anonymity is secured. In a case requiring the re-authentication of a user's identity, for example, in the case of purchasing a product, a membership system web site can request an authentication system to authenticate the user at any time. A method of authenticating the identity of a user in a state where the user's anonymity is secured will be described with reference to FIGS. 7 through 8D. Referring to FIG. 7, in step S71, a user registered in an authentication system logs on a membership system web site. Here, the user logs on using a member ID that is used only at the membership system web site so that he/she can be secured anonymity. For membership system web sites providing various services for users, it is necessary to more securely confirm the identity of a user in such a case of selling a product. FIG. 8A illustrates the example of a user interface screen for confirming whether a user to purchase a product and informing the user that the user's identity needs to be authenticated again to purchase the product. As described above, in step S72, the membership system web site determines whether it is necessary to confirm the user's identity during service. When it is determined that the confirmation is necessary, the membership system web site transmits the user's member ID and a site ID to the authentication system and requests the authentication of the user's identity in step S73. Then, in step S74, the authentication system requests the user to input an Internet ID and a password, as shown in FIG. 8B, and receives them. Here, the request and reception of the Internet ID and the password is performed only between the authentication system and the user excluding the membership system web site that has requested the authentication of the user's identity so that the Internet ID is not exposed to the outside. In step S75, the authentication system searches for the user's Internet ID based on the received member ID and the site ID and determines whether the searched Internet ID and password are the same as those currently received from the user to authenticate the user's identity. In step S76, the authentication system transmits the result of the authentication to the membership system web site. The membership system web site provides an authentication result screen as shown in FIG. 8C or 8D to the user depending on the received result.

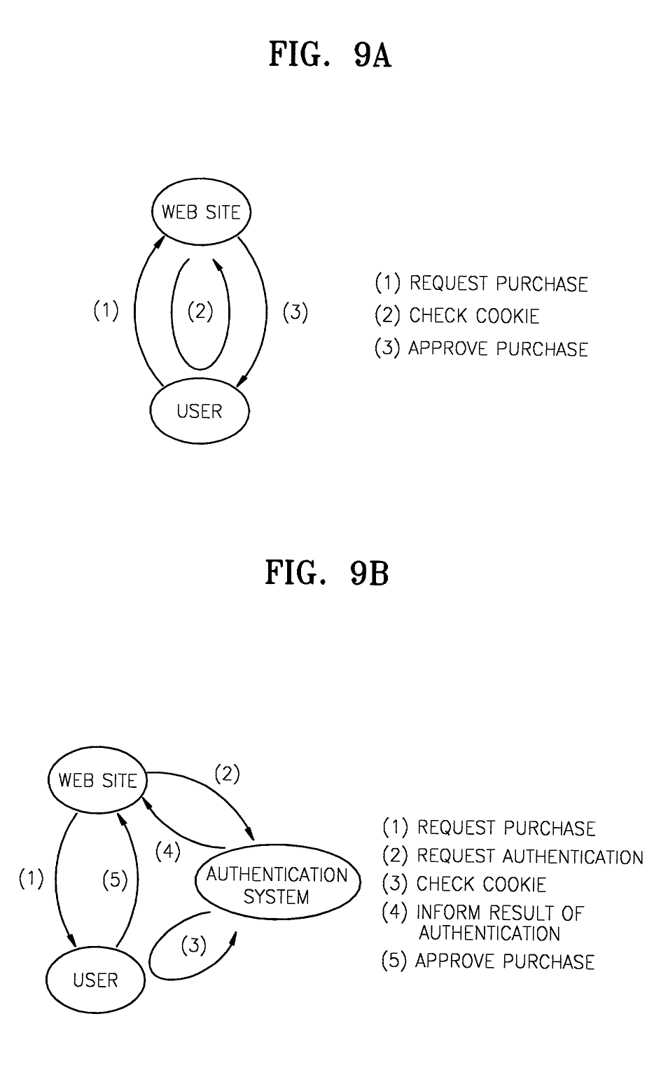

In the step S74, the user is requested to input his/her Internet ID and password, but the step S74 can be removed by obtaining the user's Internet ID and password using a cookie without involving the user. In other words, once the user initially accesses the authentication system and inputs the Internet ID and/or password, the authentication system generates a cookie including the above information and stores it at the user's terminal. Thereafter, the authentication system reads the Internet ID and/or password from the cookie when necessary. As a result, the user can enjoy a one-click shopping without a procedure of notifying the user's identity when purchasing a product. As shown in FIG. 9A, in conventional one-click shopping, once a user requests to purchase a product at a web site in step (1), the web site authenticates the user's identity using a cookie stored in the user's terminal in step (2) and approves the purchase in step (3). In this case, since web sites use different cookies, the number of cookies increases as a user registers in more web sites. However, in a one-click shopping method according to the present invention, as shown in FIG. 9B, once a user assigned an Internet ID by an authentication system notifies that he/she intends to purchase a product at a web site in step (1), the web site transmits the user's member ID and a site ID to the authentication system and requests authentication of the user's identity in step (2). The authentication system reads and processes the information of a cookie stored in the user's terminal and acquires the user's Internet ID and/or password in step (3). The authentication system compares the Internet ID and password of a user using the site ID and the member ID received in the step (2) with the Internet ID and password acquired in the step (3) and transmits the result of the authentication to the web site in step (4). The web site approves the user's purchase depending on the result of the authentication in step (5). Since the user does not need to input his/her ID and password, the user can enjoy the more convenient shopping. In addition, the user's identity can be authenticated at any web site using only one cookie. It will be apparent to those skilled in the art that in a logon state, authentication can be achieved without the user's re-input of an Internet ID and a password when another web site requests the authentication system to authenticate the user's identity or check the user's multiple registration.

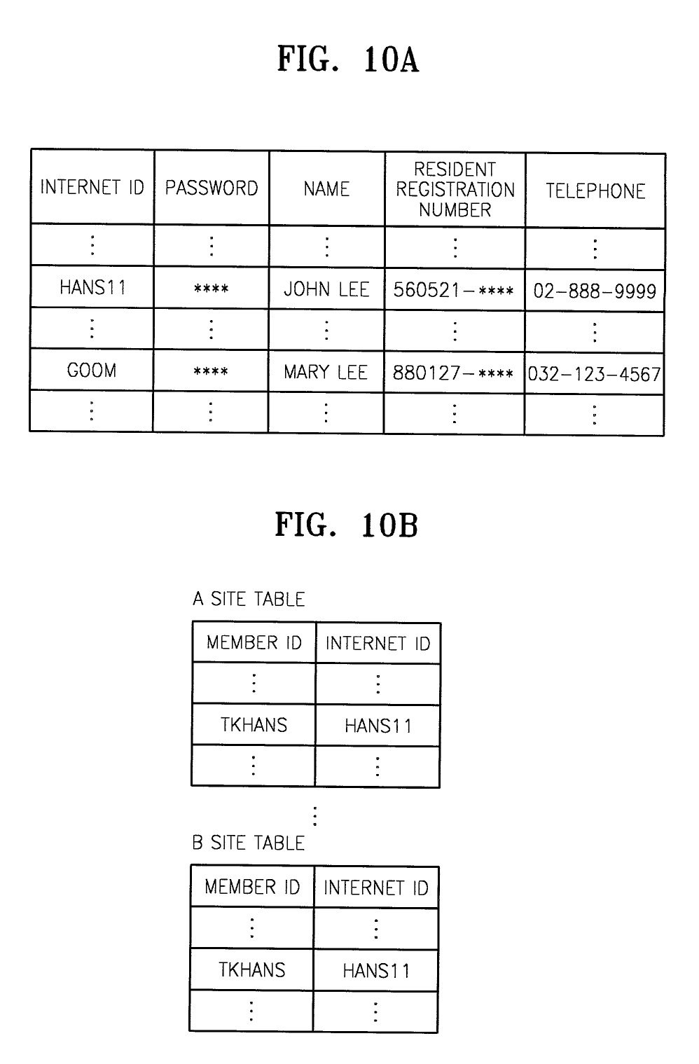

FIGS. 10A and 10B illustrate examples of a structure in which data that the authentication system 10 stores in the memory unit 102 for determining rejection or approval of authentication and decision on multiple registration. FIG. 10A is a table used for authenticating the identity of the registration applicant 12, in which Internet IDs, passwords and personal information (a name, a resident registration number, a telephone number, etc). For the Internet ID and/or the password, as well as a combination of characters and/or numerals, a personal characteristic such as a finger print, voice or handwriting sample, or a smart card can be used. Here, when using a personal characteristic such as a finger print, voice or handwriting sample as an Internet ID, a password may not be used.

FIG. 10B illustrates a structure in which Internet IDs and member IDs are stored in tables provided for each site. In the step S58, when the registration applicant 12 has not yet registered in the membership system web site 17, 18, 19 or . . . , the authentication system 10 selects a table is selected based on the received site ID and stores a pair of the member ID and the Internet ID at a single row in the table. Thereafter, when checking on multiple registration, the authentication system 10 selects a table based on the received site ID and searches the Internet ID field of the table to check whether the Internet ID of the registration applicant 12 exists or not. If the registration applicant's Internet ID does not exit, the authentication system 10 determines the registration applicant 12 as a new registrant in the membership system web site 17, 18, 19 or . . . and transmits this facts to the membership system web site 17, 18, 19 or . . . . If the registration applicant's Internet ID exits, the registration applicant 12 has already registered in the membership system web site 17, 18, 19 or . . . , so the authentication system 10 transmits this fact and a member ID used in the membership system web site 17, 18, 19 or . . . by the registration applicant 12 to the membership system web site 17, 18, 19 or . . . .

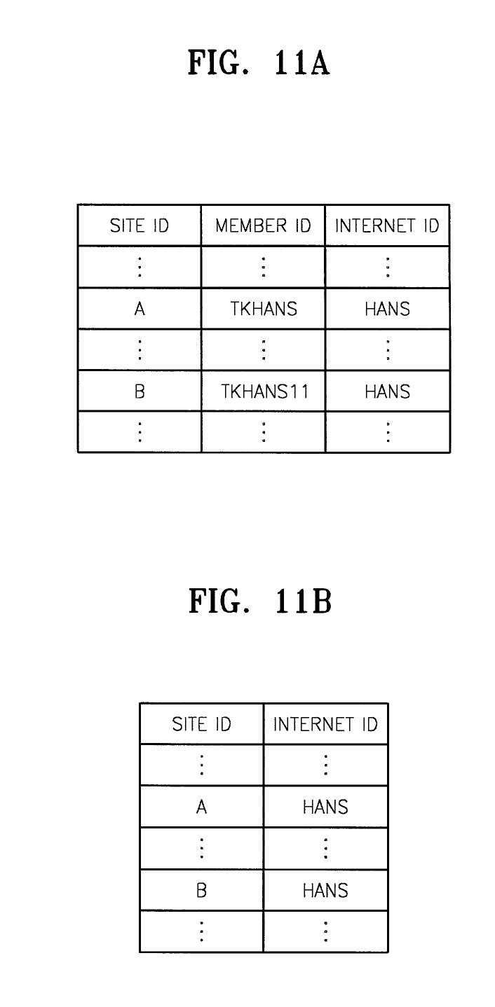

In FIG. 10B, tables are separately constructed for each site for checking on the multiple registration of a registration applicant, but various modifications can be made to the structure of FIG. 10B. FIGS. 11A and 11B illustrate other structures of a table used for checking on multiple registration. In FIG. 11A, table information of each site in FIG. 10B is constructed as a single field in a single table. Compared to FIG. 10B, the structure of FIG. 11A has advantages and disadvantages in various aspects, but it can substitute for all information providing functions fundamentally provided by the structure of FIG. 10B.

FIGS. 10B and 11A include member IDs to provide a service like notification of already registered member ID as shown in FIG. 6C when a registration applicant has already registered. If the service is not intended to be provided, the member IDs may be removed from the FIGS. 10B and 11A. A table shown in FIG. 11B is used in this case. Although services that can be provided are decreased, the storage size of the memory unit 102 can be reduced.

As described above, the present invention relates to a method and system for assigning only one Internet ID per man after authentication. The person concerned with a system site can directly check the ID card of an applicant before assigning an Internet ID, or an applicant can be assigned an Internet ID after being authenticated by a guarantor or a certification agency. When at least one person having an Internet ID stands surety for an applicant through, for example, check on the ID card, the responsibility for a false guarantee can be put on the guarantor using a penalty rule such as removing the ID, bonus or credit. The present invention can include other guarantees such as a credit guarantee and a financial guarantee as well as a fidelity guarantee. To make the registration in and use of an authentication system according to the present invention, a bonus can be given to a user based on profit from the use of and registration in the authentication system by a registrant for whom the user stood surety and by others for whom the registrant stands surety as well as the use of the user himself/herself. In the present invention, verification of an ID and a password is performed not at a membership system web site but at an authentication system, thereby enhancing the security of IDs and passwords.

Passwords cannot be revealed to the outside of the web site of the authentication system. When authenticating an Internet ID, the personal information (a name and an address necessary for delivery of a product) of an owner of the Internet ID is transmitted to a membership system web site in real time in response to the request/confirmation of the owner. An authentication system according to the present invention executes the settlement of the transaction between a commercial site and the owner of an Internet ID. The settlement can made using a credit card, automatic transfer or credit transaction settlement. Here, the authentication system may be designed to manage the cyber credit of the owner of an Internet ID and arrange the limit of the cyber credit transaction for each Internet ID. According to the present invention, the access/transaction details from a membership system web site (including a commercial transaction or an opinion poll) is reported to the owner of an Internet ID periodically or whenever there is an access or transaction through e-mail or another method, in order to prevent misappropriation of the Internet ID. As described above, according to an authentication system and method of the present invention, a user can be authenticated at any site using only one ID and password so that an additional registration procedure is not necessary due to real-time transmission of information necessary for registration. It will be done if only the authentication system updates the information on the owners of Internet IDs. The authentication system can execute settlement for the owners of Internet IDs and can manage the owners' cyber credit. For example, when the owner of an Internet ID does not pay for a credit transaction, the authentication system can prohibit the owner from making a credit transaction. Besides, the authentication system can provide all services requiring authentication.

Meanwhile, the present invention provides an environment in which an applicant for registration in a membership system web site can be assigned from the membership system web site without revealing the applicant's personal information including an Internet ID to others except an authentication system, thereby enhancing the security and the anonymity. Accordingly, a variety of services can be provided as follows.

Firstly, it is possible to search for members comforting with a particular condition and provide a variety of services such as gifts and premiums. For example, when delivering celebration gifts to members who have come of age, conventionally, it frequently happens that one person receives a plurality of gifts due to multiple registration. In the present invention, multiple registration is not allowed, so such an unfair case can be removed.

Secondarily, when a web site employing an authentication system and method according to the present invention takes a public opinion poll or a vote, only one chance per man is permitted so that the fairness can be considerably increased.

Thirdly, when a member forgot his/her ID or password necessary for accessing a membership system web site through the Internet, an authentication system authenticates the identity of the member and informs the member of the member's ID or password used in the membership system web site.

In a credit transaction such as electronic commerce, the anonymity of a user can be secured since he/she can be assigned a different ID by a different site. In addition, the safety in a transaction is ensured since a user registers in each site under the thorough authentication through an authentication system according to the present invention.

What is claimed is:

1. A method of authenticating the identity of an applicant for registration on The Internet, comprising the steps of:
(a) confirming the identity of the applicant for registration; and
(b) registering the personal information of the applicant whose identity is confirmed in an authentication system together with a password and issuing a unique Internet ID online or sending the Internet ID to the applicant's e-mail address.

2. The method of claim 1, wherein when the applicant intends to register in the authentication system with a guarantor as security, the step (a) comprises the steps of:
(a1) the applicant inputting his/her resident registration number and at least one guarantor's Internet identifier (ID) or resident registration number;
(a2) the authentication system transmitting the applicant's resident registration number and an authentication key to the guarantor;
(a3) the guarantor determining the validity of the applicant's resident registration number and transferring the authentication key to the applicant when the guarantor determines the applicant's resident registration number to be valid;
(a4) the authentication system allowing the applicant to input an ID, a password and personal information using the authentication key transferred from the guarantor when the guarantor determines the applicant's resident registration number to be valid; and
(a5) the authentication system assigning an Internet ID to the applicant.

3. The method of claim 1, wherein when the applicant intends to register in the authentication system without a guarantor, the step (a) comprises the steps of:
(a11) the applicant inputting personal information such as his/her resident registration number and address;
(a22) the authentication system requesting the applicant to visit a nearby certification agency to be authenticated;
(a33) the applicant visiting the certification agency to proceed with authentication or ending the authentication procedure without visiting the certification agency;
(a44) the certification agency confirming the applicant's identity, inputting the applicant's resident registration number to the authentication system, and receiving an authentication key;
(a55) the certification agency transferring the authentication key to the applicant and allowing the applicant to input an ID, password and personal information using the authentication key at the web site of the authentication system; and
(a66) the authentication system assigning an Internet ID to the applicant.

4. The method of claim 1, wherein for the Internet ID and/or the password, alpha numeric information, the applicant's personal characteristic such as a finger print, voice or handwriting sample, or a smart card can be used.

5. The method of claim 1, further comprising the steps of:
when the applicant assigned the Internet ID needs to be authenticated on the Internet,
(c) the applicant presenting the Internet ID to a membership system web site requiring the authentication of the applicant's identity;
(d) the membership system web site transmitting the Internet ID to the authentication system to request the authentication of the applicant's identity; and
(e) the authentication system requesting the applicant to input the password and informing the membership system web site that the applicant's identity is authenticated when the password input by the applicant is the same as that stored in the authentication system.

6. The method of claim 5, wherein the authentication system transmits personal information such as the name and address of the owner of the Internet ID required for delivery of a product, and the age, occupation and sex of the owner required for voting or public opinion polls to a membership system web site in real time in response to a request or grant of permission by the owner of the Internet ID.

7. The method of claim 5, further comprising the step of transmitting the access/transaction details of the owner of the Internet ID with respect to the membership system web site to the owner.

8. The method of claim 1, further comprising the step of checking the multiple registration of the applicant assigned the Internet ID when the applicant registers in a web site as a member or to participate in an event permitting just one chance per man, the multiple registration checking step comprising the steps of:
(f) receiving a request to check the multiple registration of the applicant and the site ID of the web site from the web site;
(g) receiving the applicant's Internet ID and password necessary for authentication on the Internet from the applicant and performing authentication; and
(h) determining whether the applicant has registered in the web site using the applicant's Internet ID and the site ID of the web site and transmitting the result of the determination to the web site.

9. The method of claim 8, wherein in the step (f), a member ID which the applicant wishes to use in the web site is also received and processed in association with the Internet ID.

10. The method of claim 9, wherein in the step (h), the member ID of the applicant is transmitted to the web site when it is determined that the applicant has already registered in the web site.

11. The method of claim 9, wherein for the member ID and/or the password, alpha numeric information, the applicant's personal characteristic such as a finger print, voice or handwriting sample, or a smart card can be used.

12. The method of claim 8, wherein in the step (h), the applicant's Internet ID is stored in association with the site ID of the web site when it is determined that the applicant has not yet registered in the web site.

13. The method of claim 8, further comprising the steps of:
when a user who has registered in the web site needs to be authenticated on the Internet,
(i) the web site transmitting the user's member ID and the site ID to the authentication system and requesting authentication of the user's identity;
(ii) the authentication system requesting the user to directly input his/her Internet ID and password or reading and processing the information of a cookie stored in the user's terminal to acquire the user's Internet ID and password; and
(k) the authentication system comparing the Internet ID and password of a user having the site ID and the member ID received in the step (i) with the Internet ID and the password acquired in the step (j) and transmitting the result to the web site.

14. The method of claim 13, wherein the cookie includes the user's Internet ID and/or password information, is generated when the user's terminal initially transmits the user's Internet ID and/or password to the authentication system and stored in the user's terminal.

15. The method of claim 13, wherein the authentication system transmits personal information such as the name and address of the owner of the Internet ID required for delivery of a product, and the age, occupation and sex of the owner required for voting or public opinion polls to a membership system web site in real time in response to a request or grant of permission by the owner of the Internet ID.

16. The method of claim 13, further comprising the step of transmitting the access/transaction details of the owner of the Internet ID with respect to the membership system web site to the owner.

17. A system for authenticating the identity of an applicant for registration on the Internet, the system comprising:
a web site server for confirming the identity of the applicant for registration in the system, registering the personal information of the applicant whose identity is confirmed together with a password under a secure state on the Internet and issuing a unique Internet ID online or sending it to the applicant's e-mail address; and
a memory unit for storing the registered applicant's Internet ID, password and personal information.

18. The system of claim 17, wherein when the applicant assigned the Internet ID needs to be authenticated on the Internet, the applicant presents the Internet ID to a membership system web site requiring the authentication of the applicant's identity, the membership system web site transmits the Internet ID to the authentication system to request the authentication of the applicant's identity, and the authentication system requests the applicant to input the password and informing the membership system web site that the applicant's identity is authenticated when the password input by the applicant is the same as that stored in the authentication system.

19. The system of claim 17 or 18, wherein for the Internet ID and/or the password, alpha numeric information, the applicant's personal characteristic such as a finger print, voice or handwriting sample, or a smart card can be used.

20. The system of claim 17, wherein when checking the multiple registration of the applicant assigned the Internet ID when the applicant registers in a web site as a member or participate in an event permitting just one chance per man, the system receives the request to check the multiple registration of the applicant and a site ID from the web site, receives the applicant's Internet ID and password necessary for authentication on the Internet from the applicant and performs authentication, and determines whether the applicant has registered in the web site using the applicant's Internet ID and the site ID of the web site and transmits the determined result to the web site.

21. The system of claim 20, wherein the system server stores the applicant's Internet ID in the memory unit in association with the site ID of the web site when it is determined that the applicant has not yet registered in the web site.

22. The system of claim 20, wherein the system server also receives a member ID to be used by the applicant in the web site in which the applicant wishes to register, and stores it in the memory unit in association with the applicant's Internet ID when it is determined that the applicant has not yet registered in the web site.

23. The system of claim 20, wherein for the member ID and/or the password, alpha numeric information, the applicant's personal characteristic such as a finger print, voice or handwriting sample, or a smart card can be used.

24. The system of claim 20, wherein the system server transmits the member ID of the applicant to the web site when it is determined that the applicant has already registered in the web site.

25. The system of claim 20, wherein when a user who has registered in the web site needs to be authenticated on the Internet, the web site transmits the user's member ID and the site ID to the authentication system and requests authentication of the user's identity, the authentication system requests the user to directly input his/her Internet ID and password or reads and processes the information of a cookie stored in the user's terminal to acquire the user's Internet ID and password, and the authentication system compares the Internet ID and password of a user having the received site ID and the member ID with acquired the Internet ID and the password and transmits the result to the web site.

26. The system of claim 25, wherein the cookie includes the user's Internet ID and/or password information, is generated when the user's terminal initially transmits the user's Internet ID and/or password to the authentication system and stored in the user's terminal.
